(19) United States
(12) Patent Application Publication
(10) Pub. No.: US 2018/0105106 A1
(43) Pub. Date: Apr. 19, 2018

(54) VEHICLE WARNING DEVICE FOR DETECTING OBJECT IN FRONT

(71) Applicant: JETEAZY SYSTEM CO., LTD., Hsinchu City (TW)

(72) Inventor: Cheng-Hsin TSAI, Cheng-Hsin (TW)

(21) Appl. No.: 15/295,998

(22) Filed: Oct. 17, 2016

(51) Int. Cl. B60Q 9/00

(52) U.S. Cl. CPC B60Q 9/008

(57) ABSTRACT

A vehicle warning device for detecting an object in front includes a distance detector, a first warning component and a second warning component. The distance detector is installed in a front bumper of a vehicle for detecting a distance between the object in front and the vehicle to output a detecting signal. The first warning component is electrically connected to the distance detector to receive the detecting signal and outputs a first warning signal when the first warning component receives the detecting signal. The first warning component is installed within a visible range of a driver. The second warning component is electrically connected to the distance detector to receive the detecting signal and outputs a second warning signal when the second warning component receives the detecting signal. The second warning component is installed within the vehicle.

### BACKGROUND OF THE INVENTION

### 1. Field of the Invention

The present invention relates to a vehicle warning device, and more particularly to a vehicle warning device for detecting objects in front.

### 2. Description of Related Art

Vehicles are one of the important transportations in modern life. When the vehicles are moving on the road and a driver does not keep a safe distance or a rear light of another vehicle in front is broken and suddenly the vehicle is forced to brake, the driver in the vehicle may not immediately determine the movement of the vehicle in front and a car crash may occur.

On the other hand, during rush hours, the driver can hardly keep a safe distance all the time. Therefore, a warning device is required to remind the driver to be aware when the vehicle is very close to the vehicle in front so as to avoid the car crashing into the vehicle in front.

### SUMMARY OF THE INVENTION

An objective of the present invention is to provide a vehicle warning device for detecting an object in front when a vehicle is very close to another vehicle in front. The vehicle warning device in the present invention will output a warning signal to notify a driver so as to avoid a car crash.

In order to achieve the aforementioned purpose in the present invention, the present invention provides a vehicle warning device for detecting an object in front and includes a distance detector, a first warning component and a second warning component.

The distance detector is installed in a front bumper of a vehicle for detecting a distance between the front object and the vehicle to output a detecting signal. The first warning component is electrically connected to the distance detector to receive the detecting signal and outputs a first warning signal, wherein the first warning component is installed within a visible range of a driver. The second warning component is electrically connected to the distance detector to receive the detecting signal and outputs a second warning signal, wherein the second warning component is installed within the vehicle.

The advantage in the present invention is to remind the driver to keep the safe distance by the first warning component and the second warning component or remind the driver to be aware that the vehicle is very close to another vehicle in front. Therefore, if the driver is fast enough to brake the vehicle, the vehicle can avoid crashing into the vehicle in front.

### BRIEF DESCRIPTION OF THE DRAWINGS

FIG. 1 is a block diagram of a vehicle warning device in the present invention; and

FIG. 2 is a view of the vehicle warning device installed on a vehicle in the present invention.

### DETAILED DESCRIPTION OF THE PREFERRED EMBODIMENT

These and other aspects of the embodiments herein will be better appreciated and understood when considered in conjunction with the following description and the accompanying drawings.

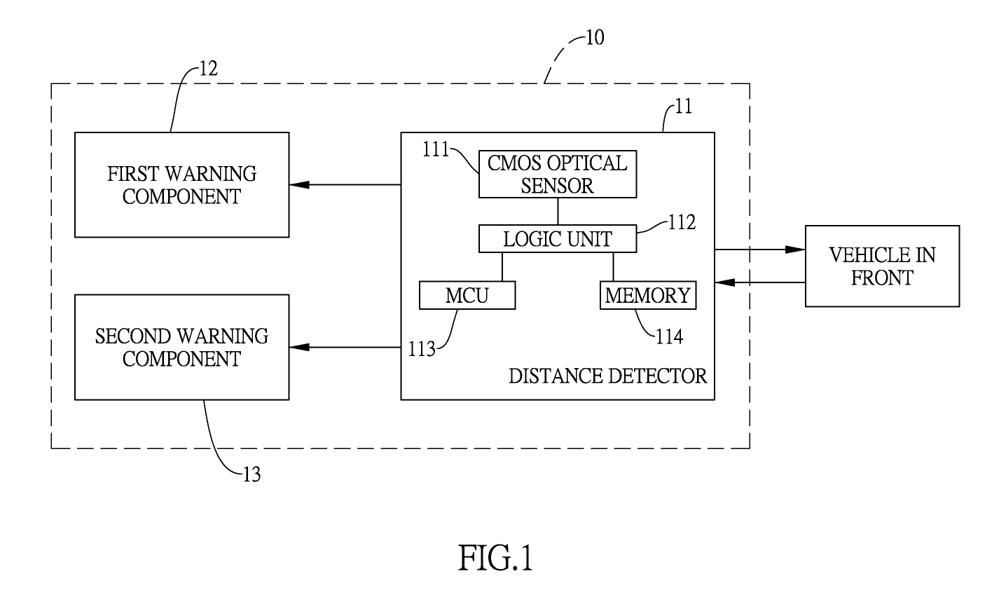

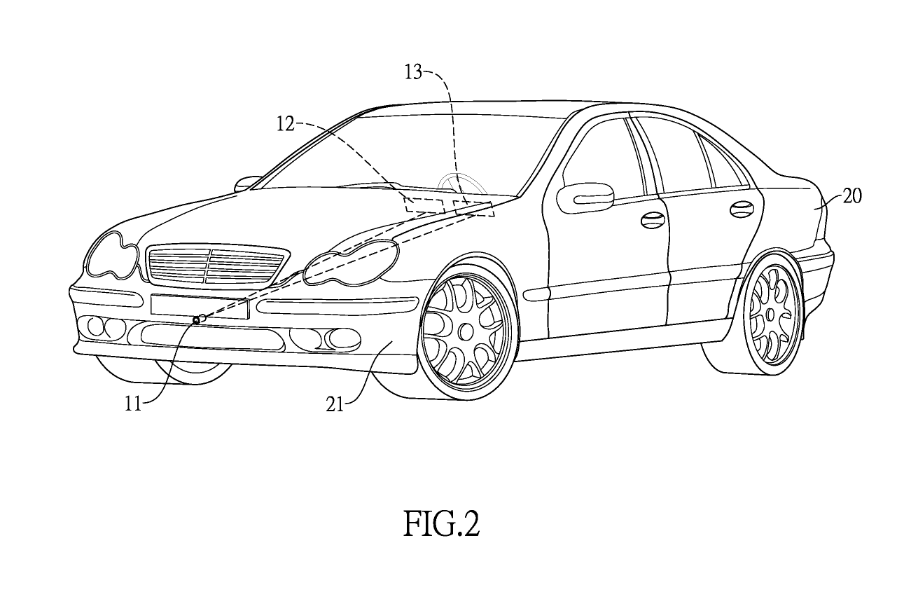

With reference to FIG. 1 and FIG. 2, a vehicle warning device 10 for detecting an object in front in the present invention includes a distance detector 11, a first warning component 12 and a second warning component 13.

The distance detector 11 is preferably disposed at a front bumper 21 of a vehicle body 20. The first warning component 12 and the second warning component 13 are respectively and electrically connected to the distance detector 11. The distance detector 11 outputs a detecting signal to the first warning component 12 and the second warning component 13. When the first warning component 12 and the second warning component 13 receive the detecting signal from the distance detector 11, the first warning component 12 and the second warning component 13 will each transmit a warning signal to a driver. Therefore, the driver will be aware that the distance between the vehicle body 20 and the vehicle in front is too short and has to drive more carefully. The first warning component 12 is preferred to be an illuminant device, such as a warning light, an LED (Light Emitting Diode) light and so on. The first warning component 12 may be disposed on a dashboard within the vehicle body 20 or disposed on a front panel between a windshield and a steering wheel. The first warning component 20 may also be disposed on the steering wheel. A region within a visible range of the driver can be a setting position for the first warning component 12. The second warning component 13 is preferred to be an audio device, such as a speaker and so on. Alternatively, the second warning component 13 may be a horn of the vehicle and it is not limited herein. Any positions within the vehicle body 20 can be the setting position for the second warning component 13. As long as the sound generated by the second warning component 13 can be heard by the driver, the location of the second warning component 13 can be the setting position.

In the present invention, the distance detector 11 is preferred to be an optical shifting detector. The distance detector 11 includes a CMOS (Complementary Metal-Oxide-Semiconductor) optical sensor 111, a logic unit 112, a microprocessor (MCU) 113 and a memory 114. The logic unit 112 is electrically connected to the CMOS optical sensor 111. The MCU 113 is electrically connected to the logic unit 112 and the memory 114 is electrically connected to the MCU 113. The optical shifting sensor is to emit light on an object in front and implements the CMOS optical sensor 111 to determine lighting changes reflected from the object. Thereafter, the lighting changes are transmitted to the logic unit 112 to perform an image processing and the logic unit outputs a distance signal to the MCU 113. The MCU 113 performs a comparison between the distance signal and a preset distance data saved in the memory 114. If the distance represented by the distance signal is less than the distance represented by the preset distance data in the memory 114, the vehicle body 20 is very close to the vehicle in front. The distance between the vehicle body 20 and the vehicle in front is less than the safe distance, and the determining signal is outputted to the first warning component 12 and the second warning component 13. How to set up the distance data by the distance detector 11 is well known for a person with ordinary skill in the art, and the detailed description thereof is omitted herein.

After the first warning component 12 receives the determining signal, the first warning component 12 generates a first warning signal and the first warning signal is an optical signal with warning effect. After the second warning component 13 receives the determining signal, the second warning component 13 generates a second warning signal and the second warning signal is an audio signal with warning effect. By the double warning effect, the driver is aware that the vehicle body 20 is very close to the vehicle in front and the speed of the vehicle body 20 has to be decreased so as to increase the distance between the vehicle body 20 and the vehicle in front. Therefore, a car accident such as the vehicle body 20 hitting the vehicle in front can be avoided.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A vehicle warning device for detecting an object in front, comprising:
a distance detector installed in a front bumper of a vehicle for detecting a distance between the object in front and the vehicle to output a detecting signal;
a first warning component electrically connected to the distance detector to receive the detecting signal and outputting a first warning signal when the first warning component receives the detecting signal, wherein the first warning component is installed within a visible range of a driver;
a second warning component electrically connected to the distance detector to receive the detecting signal and outputting a second warning signal when the second warning component receives the detecting signal, wherein the second warning component is installed within the vehicle.

2. The vehicle warning device as claimed in claim 1, wherein the distance detector is an optical distance detector and includes:
a CMOS optical sensor;
a logic unit electrically connected to the CMOS optical sensor;
an MCU electrically connected to the logic unit;
wherein the optical distance detector transmits light to the object in front, and the CMOS optical sensor detects a lighting change of the light reflected from the object in front and transmits the lighting change to the logic unit to perform an image processing to output a distance signal to the MCU.

3. The vehicle warning device as claimed in claim 2, further including a memory electrically connected to the MCU for storing a preset distance data;
wherein the MCU compares the distance signal and the preset distance data stored in the memory, and the MCU outputs the detecting signal to the first warning component or the second warning component when a distance of the distance signal is less than the distance of the preset distance data, which represents that the vehicle is very close to the object in front.

4. The vehicle warning device as claimed in claim 1, wherein the first warning component is an optical device and the first warning signal is an optical signal.

5. The vehicle warning device as claimed in claim 2, wherein the first warning component is an optical device and the first warning signal is an optical signal.

6. The vehicle warning device as claimed in claim 3, wherein the first warning component is an optical device and the first warning signal is an optical signal.

7. The vehicle warning device as claimed in claim 1, wherein the second warning component is an audio device and the second warning signal is an audio signal.

8. The vehicle warning device as claimed in claim 2, wherein the second warning component is an audio device and the second warning signal is an audio signal.

9. The vehicle warning device as claimed in claim 3, wherein the second warning component is an audio device and the second warning signal is an audio signal.

10. The vehicle warning device as claimed in claim 1, wherein the first warning component is disposed on a dashboard within the vehicle body.

11. The vehicle warning device as claimed in claim 2, wherein the first warning component is disposed on a dashboard within the vehicle body.

12. The vehicle warning device as claimed in claim 3, wherein the first warning component is disposed on a dashboard within the vehicle body.

13. The vehicle warning device as claimed in claim 1, wherein the first warning component is disposed on a front panel between a steering wheel and a windshield within the vehicle body.

14. The vehicle warning device as claimed in claim 2, wherein the first warning component is disposed on a front panel between a steering wheel and a windshield within the vehicle body.

15. The vehicle warning device as claimed in claim 3, wherein the first warning component is disposed on a front panel between a steering wheel and a windshield within the vehicle body.
